(19) United States
(12) Patent Application Publication
(10) Pub. No.: US 2006/0023139 A1
(43) Pub. Date: Feb. 2, 2006

(54) Liquid crystal display panel

(75) Inventor: Aleck Chen, Taichung (TW)

Correspondence Address: BINGHAM, MCCUTCHEN LLP, THREE EMBARCADERO CENTER, 18 FLOOR, SAN FRANCISCO, CA, 94111-4067, US

(73) Assignee: Twinwill Optronics Inc., Taipei (TW)

(21) Appl. No.: 10/899,032

(22) Filed: Jul. 27, 2004

(51) Int. Cl. G02F 1/1333

(52) U.S. Cl. 349/58

(57) ABSTRACT

A liquid crystal display panel provides brighter images and better resistance to shock damages and has a plastic frame, four shock-absorbing bars, a base board, a high effective reflector film, a light guide sheet, a prism sheet, a doubled-enhanced film, a liquid crystal glass, an anti-reflector film and a metallic frame. The high effective reflector film with a high efficiency reflective coat and the doubled-enhanced film increase the brightness of the liquid crystal display panel. The anti-reflector film reduces glare from outside light. The shock-absorbing bars isolate the internal components from the frame and provide resistance to shock damage.

### BACKGROUND OF THE INVENTION

1. Field of the Invention

The present invention relates to a liquid crystal display panel, especially to a liquid crystal display panel with a high brightness.

2. Description of the Prior Art

With reference to FIG. 2, a conventional liquid crystal display panel comprises a plastic frame (20), a reflector film (21), a light guide sheet (22), a prism sheet (23), a diffuser sheet (24), a liquid crystal glass (25), a circuit board (27) and a metallic frame (26).

The plastic frame (20) supports all components of the conventional liquid crystal display panel and holds the components in position. The reflector film (21) is attached to the plastic frame (20) and reflects the light. The light guide sheet (22) is attached to the reflector film (21) and transmits the light evenly. The prism sheet (23) is attached to the light guide sheet (22) to collect the light transmitted from the light guide sheet (22) to the liquid crystal glass (25). The diffuser sheet (24) is attached to the prism sheet (23) and diffuses the light to distribute the light evenly. The circuit board (27) is mounted on the liquid crystal glass (25) and controls the liquid crystal glass (25). The liquid crystal glass (25) is attached to the diffuser sheet (24). The metallic frame (18) is attached to the plastic frame (10) to hold the components of the liquid crystal display panel together.

Liquid crystal displays are often used in notebook computers that are often used outdoors in bright sunlight. In such circumstances, conventional liquid crystal displays are often not bright enough to see clearly.

Furthermore, use of devices with liquid crystal displays outdoors makes the displays susceptible to shocks. The components of the conventional liquid crystal display do not have any shock-absorbing features. Consequently, bumping dropping, hitting stepping on the display or the application of virtually any significant shock to the conventional liquid crystal display will easily damage the liquid crystal display.

To overcome the shortcomings, the present invention provides a liquid crystal display panel to mitigate or obviate the aforementioned problems.

### SUMMARY OF THE INVENTION

The main objective of the present invention is to provide a liquid crystal display panel with a high brightness. The liquid crystal display panel comprises a plastic frame, four shock-absorbing bars, a base board, a high effective reflector film, a light guide sheet, a prism sheet, a doubled-enhanced film, a liquid crystal glass, an anti-reflector film and a metallic frame.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a liquid crystal display panel in accordance with the present invention; and

FIG. 2 is an exploded perspective view of a conventional liquid crystal display panel in accordance with the prior art.

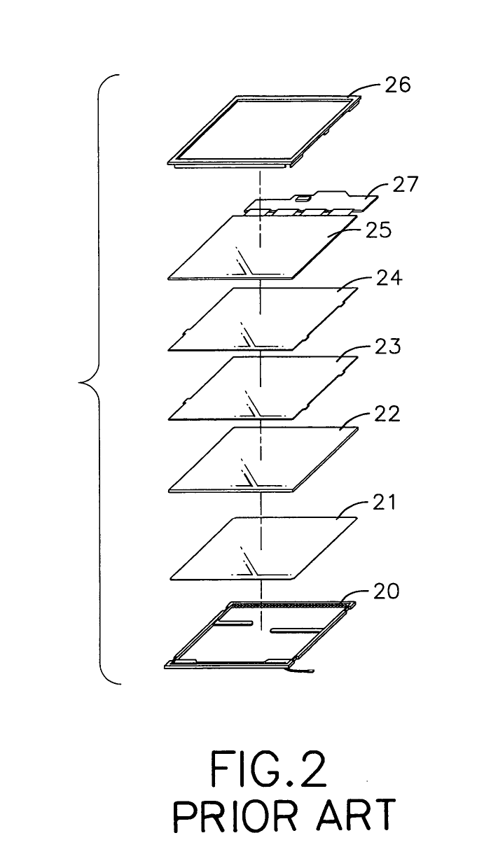

### DETAILED DESCRIPTION OF THE PREFERRED EMBODIMENTS

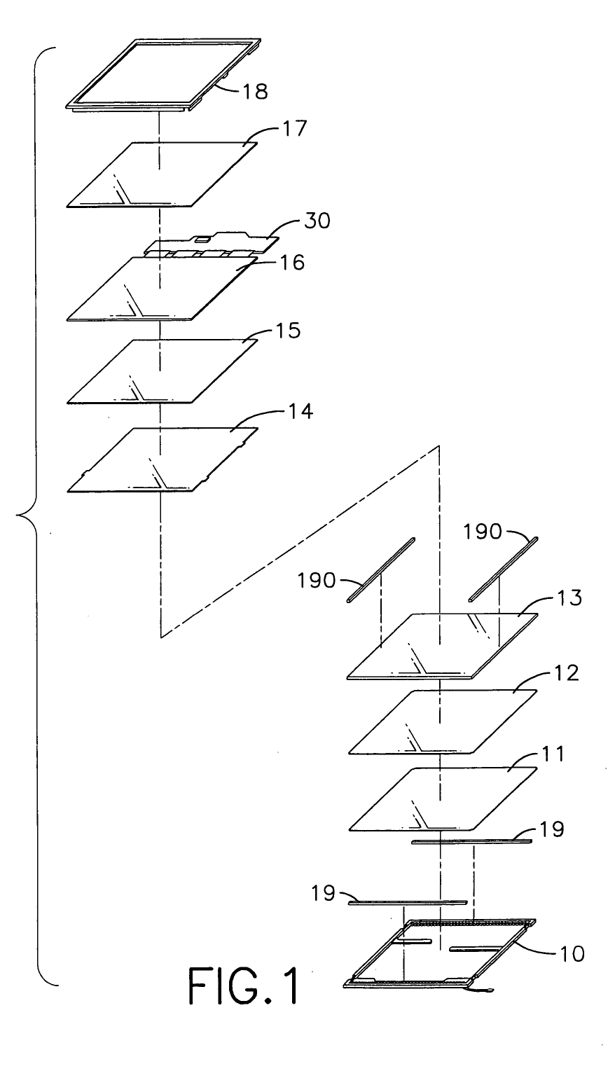

With reference to FIG. 1, a liquid crystal display panel in accordance with the present invention comprises a plastic frame (10), two lower shock-absorbing bars (19), two upper shock-absorbing bars (190), a base board (11), a high effective reflector film (12), a light guide sheet (13), a prism sheet (14), a doubled-enhanced film (15), a liquid crystal glass (16), a-circuit board (30), an anti-reflector film (17) and a metallic frame (18).

The plastic frame (10) has four edges. The lower shock-absorbing bars (19) are attached in parallel respectively to two opposite edges of the plastic frame (10). The plastic frame (10) supports and holds the other components of the liquid crystal display panel.

The base board (11) is mounted in the plastic frame (10) on the lower shock-absorbing bars (19) and stiffens and strengthens the liquid crystal display panel. The base board (11) is a rigid material like a plastic or a metal.

The high effective reflector film (12) is attached to the base board (11) and has a high efficiency reflective coat. The reflective coat increases the reflective efficiency of the high effective reflector film (12) so the high effective reflector film (12) reflects more light.

The light guide sheet (13) is attached to the high effective reflector film (12), corresponds to the high effective reflector film (12) and the base board (11) and has four edges corresponding to and mounted in the edges of the plastic frame (10).

The upper shock-absorbing bars (190) are mounted in parallel on opposite edges of the light guide sheet (13) perpendicular to the lower shock-absorbing bars (19) mounted in the plastic frame (10). The light guide sheet (13) transmits the light evenly.

The prism sheet (14) is attached to the light guide sheet (13) to collects the light transmitted from the light guide sheet (13) to the liquid crystal glass (16).

The doubled-enhanced film (15) is attached to the prism sheet (14) and increases the brightness of the light.

The liquid crystal glass (16) is attached to the doubled-enhanced film (15) and has four edges.

The circuit board (30) is attached to one edge of the liquid crystal glass (16) and forms images in the liquid crystal glass (16).

The anti-reflector film (17) is attached to the liquid crystal glass (16) to reduce glare from outside light.

The metallic frame (18) is attached to the plastic frame (10) to hold all the components of the liquid crystal display panel together.

The liquid crystal display panel as described significantly mitigates the disadvantages of the conventional liquid crystal display panel. The high effective reflector film (12) and the doubled-enhanced film (15) increase the brightness of the liquid crystal display panel. The anti-reflector film (17) decreases glare from outside light especially outdoors. The shock-absorbing bars (19) make the liquid crystal display panel resilient to shock and less likely to be damaged by shock.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A liquid crystal display panel comprising
a plastic frame having;
four edges;
two lower shock-absorbing bars mounted respectively on opposite edges of the plastic frame;
a base board mounted in the plastic frame on the lower shock-absorbing bars;
a high effective reflector film attached to the base board and having;
a reflective coat coated on the high effective reflector film;
a light guide sheet attached to the high effective reflector film, corresponding to the high effective reflector film and the base board and having;
four edges corresponding to and mounted in the edges of the plastic frame;
two upper shock-absorbing bars mounted in parallel on opposite edges of the light guide sheet perpendicular to the lower shock-absorbing bars;
a prism sheet attached to the light guide sheet;
a doubled-enhanced film attached to the prism sheet;
a liquid crystal glass attached to the doubled-enhanced film and having four edges;
a circuit board attached to one edge of the liquid crystal glass to form images in the liquid crystal glass;
an anti-reflector film attached to the liquid crystal glass; and
a metallic frame attached to the plastic frame.

2. The liquid crystal display panel as claimed in claim 1 wherein the base board is made of plastic.

3. The liquid crystal display panel as claimed in claim 1 wherein the base board is made of metal.
